(19) United States
(12) Patent Application Publication
(10) Pub. No.: US 2026/0145204 A1
(43) Pub. Date: May 28, 2026

(54) ACTUATOR RESONANT FREQUENCY DETECTION VIA ZERO PHASE TRACKING

(71) Applicant: QUALCOMM Incorporated, San Diego, CA (US)

(72) Inventors: Hari VASUDEVAN, Bangalore (IN); Venkata Mohana Vamsi VOORA, Eluru (IN); Shyama P, Kozhikode (IN)

(21) Appl. No.: 18/963,354

(22) Filed: Nov. 27, 2024

(51) Int. Cl. B06B 1/04; B06B 1/02; G06F 1/16; G06F 3/01

(52) U.S. Cl. CPC B06B 1/045; B06B 1/0215; G06F 1/163; G06F 3/016

(57) ABSTRACT

Systems and techniques are described for producing haptic effects. For example, a computing device can apply, to an actuator of the computing device, a signal with a frequency. The computing device can monitor a measure of a phase difference associated with a power associated with the signal applied to the actuator. The computing device can determine, based on determining the measure of the phase difference is equal to zero, the frequency is a resonant frequency of the actuator. The computing device can produce, based on the actuator operating at the resonant frequency, the one or more haptic effects at the computing device.

### FIELD

The present disclosure generally relates to producing haptic effects. For example, aspects of the present disclosure relate to actuator (e.g., such as a linear resonant actuator) resonant frequency detection via zero phase tracking.

### BACKGROUND

Haptics effects (e.g., haptic output) are widely used on mobile and wearable devices to create notifications, to emulate the tactile feel of mechanical buttons such as a keyboard or a home key on a mobile device, to create user feedback, as well as to be used with ringtones and many other use cases. For example, haptic effects can be used to create an experience of touch to a user that can mimic the feel of depressing a mechanical button by applying forces, vibrations, and/or motions to the user. As such, haptic effects can enhance the user experience by providing tactile responses to user interactions with digital devices.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for producing haptic effects at devices. In some aspects, a method for producing one or more haptic effects at a device is provided. The method includes: applying, to an actuator of the device, a signal with a frequency; monitoring a measure of a phase difference associated with a power associated with the signal applied to the actuator; determining, based on determining the measure of the phase difference is equal to zero, the frequency is a resonant frequency of the actuator; and producing, based on the actuator operating at the resonant frequency, the one or more haptic effects at the device.

In some aspects, an apparatus for producing one or more haptic effects is provided. The apparatus includes at least one memory and at least one processor coupled to the at least one memory and configured to: cause a signal with a frequency to be applied to an actuator; monitor a measure of a phase difference associated with a power associated with the signal applied to the actuator; determine, based on a determination that the measure of the phase difference is equal to zero, the frequency is a resonant frequency of the actuator; and based on the actuator operating at the resonant frequency, cause the one or more haptic effects to be output at the apparatus.

In some aspects, a non-transitory computer-readable medium having stored thereon instructions that, when executed by at least one processor, cause the at least one processor to: cause a signal with a frequency to be applied to an actuator; monitor a measure of a phase difference associated with a power associated with the signal applied to the actuator; determine, based on a determination that the measure of the phase difference is equal to zero, the frequency is a resonant frequency of the actuator; and based on the actuator operating at the resonant frequency, cause the one or more haptic effects to be output at the apparatus.

In some aspects, an apparatus for producing one or more haptic effects is provided. The apparatus includes: means for applying, to an actuator of the device, a signal with a frequency; means for monitoring a measure of a phase difference associated with a power associated with the signal applied to the actuator; means for determining, based on a determination that the measure of the phase difference is equal to zero, the frequency is a resonant frequency of the actuator; and means for producing, based on the actuator operating at the resonant frequency, the one or more haptic effects at the device.

In some aspects, one or more of the devices or apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the device(s)/apparatus(es) can include a camera (e.g., an RGB camera) or multiple cameras for capturing one or more images and/or one or more videos including video frames. In some aspects, the device(s)/apparatus(es) includes at least one display for displaying one or more images, videos, notifications, or other displayable data. In some aspects, the device(s)/apparatus(es) includes at least one transmitter configured to transmit one or more video frame and/or syntax data over a transmission medium to at least one device. In some aspects, the at least one processor includes a central processing unit (CPU), a digital signal processor (DSP), a neural processing unit (NPU), a neural signal processor (NSP), a graphics processing unit (GPU), any combination thereof, and/or other processing device or component.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of a system for generating haptic effects for a device, in accordance with some aspects of the disclosure.

FIG. 2 is a diagram illustrating an example of a system for generating haptic effects for a device, in accordance with some aspects of the disclosure.

FIG. 3 is a diagram illustrating an example of a linear model for modeling a linear resonant actuator (LRA), in accordance with some aspects of the disclosure.

FIG. 4 is a diagram illustrating examples of use cases for actuator (e.g., LRA) resonant frequency detection via zero phase tracking, in accordance with some aspects of the disclosure.

FIG. 5 is a diagram illustrating an example of an acceleration profile of an actuator that produces a familiar haptic experience to a user, in accordance with some aspects of the disclosure.

FIG. 6 is a diagram illustrating an example of an acceleration profile of an actuator that produces a haptic experience that is unusual to a user, in accordance with some aspects of the disclosure.

FIG. 7 is a graph illustrating examples of resonant frequencies of an actuator (e.g., LRA) based on different grips of a device by a user, in accordance with some aspects of the disclosure.

FIG. 8 is diagram illustrating an example of a system for actuator (e.g., LRA) resonant frequency detection via zero phase tracking, in accordance with some aspects of the disclosure.

FIG. 9 is a diagram illustrating an example of tracking a resonant frequency of an actuator (e.g., LRA) when updating (or sweeping) a frequency applied to actuator over time, in accordance with some aspects of the disclosure.

FIG. 10 is a diagram illustrating another example of tracking a resonant frequency of an actuator (e.g., LRA) when updating (or sweeping) a frequency applied to actuator over time, in accordance with some aspects of the disclosure.

FIG. 11 is a flow diagram illustrating an example of a process for actuator (e.g., LRA) resonant frequency detection via zero phase tracking, in accordance with some aspects of the disclosure.

FIG. 12 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Currently, haptics effects (e.g., haptic output) are widely used on mobile and wearable devices to create notifications, to emulate the tactile feel of mechanical buttons such as a keyboard or a home key on a mobile device, to create user feedback, as well as to be used with ringtones and many other use cases. For example, haptic effects can be used to create an experience of touch to a user that can mimic the feel of depressing a mechanical button by applying forces, vibrations, and/or motions to the user. As such, haptic effects can enhance the user experience by providing tactile responses to user interactions with digital devices.

In some cases, such haptic effects can be achieved by driving a Linear Resonant Actuator (LRA). Drive waveforms can be generated using electro-mechanical models, where model parameters can be extracted using various modeling techniques, such as using voltage and current sensing and acceleration measurements. Once an accurate model is derived for an LRA, algorithms (e.g., haptic algorithms) can be developed to generate specific vibration acceleration profiles.

LRAs are currently widely used in consumer electronics (e.g., mobile devices associated with users) to provide haptic feedback to the users regarding events in a user interface (UI) of the device and/or messages communicated by the device. Examples of haptics effects can include virtual button clicks, ringtone vibrations, and/or other effects. However, the key to designing haptic effects is based on knowledge of a resonant frequency of the actuator (e.g., LRA) with a high level of accuracy. Determination of the resonant frequency with accuracy can enable the creation of a consistent haptic vibration (e.g., with a maximum possible haptic effect) that does not change with the ageing of the device, the way the device is held (e.g., a tight or loose grip) by a user of the device, and/or the ambient conditions (e.g., humidity and temperature) of the device.

For producing LRA haptic effects, the estimation of the resonant frequency (f0) can have some constraints. For one example constraint, a waveform (e.g., a sinusoid waveform) that is applied to the actuator during the estimation of the resonant frequency of the actuator (e.g., LRA) should be consistent such that the actuator produces a haptic effect that can be accepted by the user as being a “typical” or “expected” vibration pattern of the device. For another example constraint, the waveform should be as short as possible during the time the resonant frequency is detected, because longer waveforms are typically only used for ringtone waveforms that are used with a lower frequency, which can consequently reduce the probability of estimating the resonant frequency often.

There can be different causes that can change or shift the resonant frequency of an actuator (e.g., LRA). For one example of a cause that can change or shift the resonant frequency, the strength of grip of a device (e.g., including the LRA) by a user (e.g., which can be referred to as a “boundary condition” change) can change or shift the resonant frequency of the LRA up to two (2) Hertz (Hz). For another example of a cause that can change or shift the resonant frequency, although LRAs are generally treated as first order systems, LRA modules can exhibit non-linearities such that the resonant frequency can change with signal amplitude. For some LRAs, the resonant frequency can be dependent upon “Duffing Oscillator” effects (e.g., similar effects can be seen in micro-electromechanical systems (MEMS) gyroscope oscillators), which can cause the resonant frequency to jump intermittently. For another example of a cause that can change or shift the resonant frequency, long term changes in the LRA spring stiffness (e.g., due to stress-strain curve changes) can change or shift the resonant frequency of the LRA.

Existing approaches to estimate the resonant frequency of an actuator (e.g., LRA) typically employ either a wide spectrum waveform (e.g., a chirp) or a series of short pulses to measure the actuator resonant frequency ringdown. The haptic effects, which are produced based on these waveforms, are difficult to incorporate into user facing haptic vibrations because these haptic effects are generally an unexpected vibration pattern to the user.

As such, improved systems and techniques for estimating a resonant frequency of an actuator (e.g., LRA) with accuracy, while providing an expected haptic effect to the user during the estimation, can be beneficial.

In one or more aspects of the present disclosure, systems, apparatuses, methods (also referred to as processes), and computer-readable media (collectively referred to herein as “systems and techniques”) are described herein that provide solutions for actuator (e.g., LRA) resonant frequency detection via zero phase tracking.

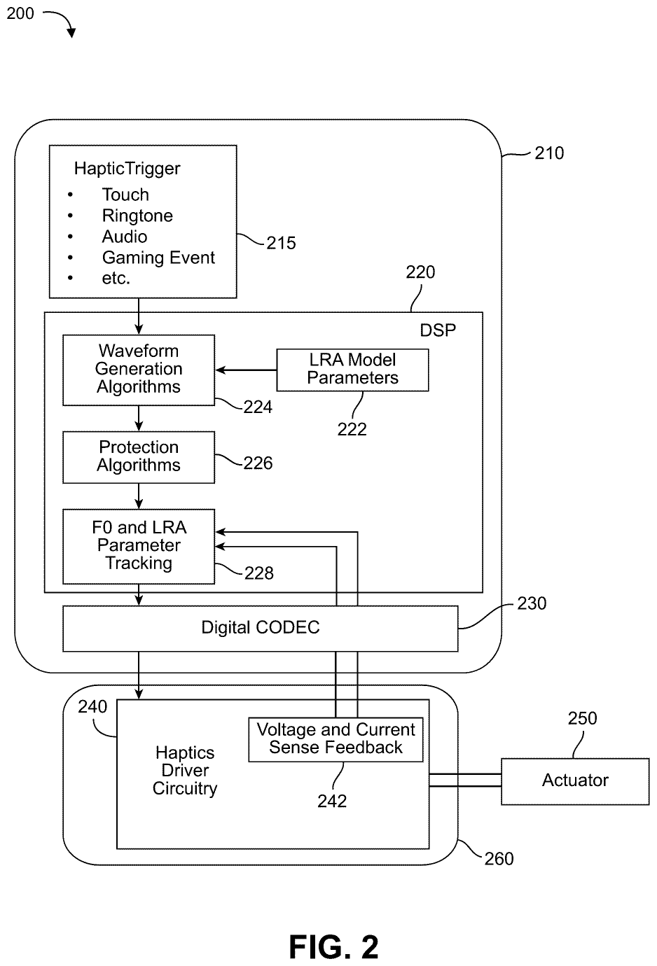

Various aspects relate generally to producing haptic effects. Some aspects more specifically relate to systems and techniques that provide solutions that use voltage and current (VI) sensing capabilities of device drivers (e.g., haptic driver circuitry 240 of FIG. 2) with a zero phase property of the actuators (e.g., LRAs) to create a resonant frequency tracking system (e.g., a closed loop system), which operates similarly to a phase lock loop (PLL).

In one or more examples, typically, for a closed loop system, it is critical to understand the latency in the control loop when designing a tracker. However, the systems and techniques provide solutions for a closed loop system (e.g., that tracks the zero phase property of an actuator) that is not tightly bound to the requirement for known latencies. By tracking the zero phase property of an actuators (e.g., LRA), the closed loop system is not dependent upon the accuracy of the sensed voltage and current, which can vary due to the ambient conditions (e.g., temperature) and/or age of the amplifiers of the device.

In one or more aspects of the systems and techniques, during operation of a method of producing one or more haptic effects at a device, a frequency generator can apply, to an actuator of the device, a signal with a frequency swept over time. In one or more examples, the signal can be sinusoidal. The actuator can generate, based on the signal, a voltage and a current. A multiplier can multiply a quadrature component of the voltage and an in-phase component of the current to generate a power. One or more processors can monitor a measure of a phase difference between the current and the voltage, wherein the measure of the phase difference is based on an offset phase of the power. The one or more processors can determine, based on determining the measure of the phase difference between the current and the voltage is equal to zero (0), the frequency is a resonant frequency of the actuator. The actuator can produce, based on operating at the resonant frequency, the one or more haptic effects at the device.

In some aspects, the one or more processors can continue to update a frequency of a sinusoid stimulus (e.g., a sinusoid waveform) based on the measure of the phase difference (e.g., until the measure of the phase difference is equal to zero (0)). For instance, in some cases, the frequency of the signal can be continuously updated (or swept) over the time during operation of the device by a user. In some examples, the frequency of the signal can be set and then updated/swept based on a previously known resonant frequency of the actuator or manufacturer tolerances of a specified resonant frequency of the actuator. In one or more examples, the resonant frequency can be dependent upon a grip of the device by a user, tightness of wear of the device by the user, aging of the device, ambient conditions of the device, a temperature of the device, and/or a humidity of the device. In some examples, the offset phase of the power can be a direct current (DC) offset phase. In one or more examples, the actuator can be a linear resonant actuator (LRA). In some examples, the device can be a mobile device. In one or more examples, the mobile device can be a mobile phone, a smart watch, or a head-mounted device.

Particular aspects of the subject matter described in this disclosure can be implemented to realize one or more of the following potential advantages. In one or more examples, the systems and techniques employ a short sinusoidal waveform to measure the actuator resonant frequency ringdown, which provides the benefit of producing short sinusoidal vibrations, which are easy to accommodate into a user facing haptic effect because these short sinusoid vibrations are an expected vibration pattern to the user. In one or more examples, the systems and techniques provide the benefit of being able to track any change in the resonant frequency during the estimation of the resonant frequency and, as such, are potentially able to estimate a grip (e.g., loose or tight) of the device by a user. Existing approaches to estimate the resonant frequency of an actuator (e.g., LRA) assume that the user grip of a device does not change during the estimation of the resonant frequency.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, a computing device or other device may be a wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

As previously mentioned, haptics effects (e.g., haptic output) are currently widely utilized on mobile and wearable devices to create notifications, to emulate the tactile feel of mechanical buttons (e.g., on a keyboard or a home key on a mobile device), to create user feedback, and to be used with ringtones and many other use cases. For example, haptic effects may be used to create an experience of touch to a user that can mimic the feel of depressing a mechanical button by applying forces, vibrations, and/or motions to the user. Therefore, haptic effects can enhance the user experience by providing tactile responses to user interactions with digital devices.

In some cases, such haptic effects can be achieved by driving a Linear Resonant Actuator (LRA). Drive waveforms may be generated using electro-mechanical models, where model parameters can be extracted using various modeling techniques (e.g., using voltage and current sensing and acceleration measurements). Once an accurate model is derived for an LRA, algorithms (e.g., haptic algorithms) can be developed to produce specific vibration acceleration profiles.

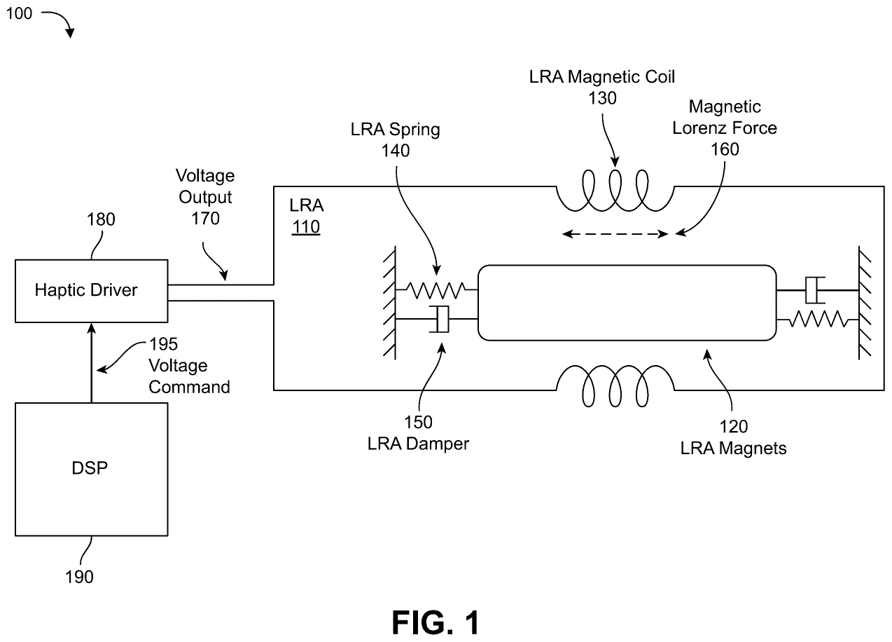

FIG. 1 shows an example system for generating haptic effects that includes an actuator in the form of an LRA. In particular, FIG. 1 is a diagram illustrating an example of a system 100 for generating haptic effects for a device (e.g., a mobile device, such as a mobile phone, smart watch, or head-mounted device). In FIG. 1, the system 100 is shown to include an LRA 110, a haptic driver 180, and a digital signal processor (DSP) 190. The LRA 110 is shown to include LRA magnetic coils 130, LRA dampers 150, LRA springs 140, and a LRA magnet 120 (e.g., which may be referred to as a mass). Each side of the LRA magnet 120 (e.g., the mass) is shown to be connected to a respective LRA spring 140. In one or more examples, the system 100 may be associated with and/or included within the device.

During operation of the system 100 for generating haptic effects for a device, the DSP 190 can determine, based on one or more model parameters of the LRA 110 (e.g., LRA specification parameters from the manufacturer of the LRA), a haptic waveform (e.g., a short haptic waveform) for the LRA 110. The DSP 190 can generate a voltage command 195 based on the determined haptic waveform. The DSP 190 can then send (e.g., transmit) the voltage command 195 to the haptic driver 180. After receiving the voltage command 195 from the DSP 190, the haptic driver 180 can generate, based on the voltage command 195, a voltage output 170 (e.g., a drive voltage). The haptic driver 180 can send (e.g., apply) the voltage output 170 (e.g., the drive voltage) to the LRA 110 to drive the LRA magnetic coils 130.

When the voltage output 170 (e.g., the drive voltage) is applied to the LRA magnetic coils 130, the LRA magnetic coils 130 are energized, which causes (e.g., by a magnetic Lorenz force 160) the LRA magnet 120 (e.g., the mass) to move from its original center position within the LRA 110 in one direction (e.g., to the left or to the right). Once the voltage output 170 (e.g., the drive voltage) is no longer applied to the LRA magnetic coils 130, the LRA magnetic coils 130 are no longer energized, which will cause the LRA magnet 120 (e.g., the mass) to move back towards the center position within the LRA 110. The LRA magnet 120 (e.g., the mass) may oscillate back and forth (e.g., to the left and to the right) until coming to a complete stop in the center position of the LRA 110.

FIG. 2 shows an example system for producing haptic effects. In particular, FIG. 2 is a diagram illustrating an example of a system 200 for generating haptic effects for a device. In FIG. 2, a system on a chip (SOC) 210, a PMIC 260 (e.g., including haptics driver circuitry 240), and an actuator 250 (e.g., LRA) are shown. The PMIC 260 can directly interface and drive the actuator 250.

The SOC 210 is shown to include a haptic trigger 215, an embedded DSP 220, and a digital codec 230. The haptic trigger 215 can include one or more triggers (e.g., touch, a ringtone, audio, and/or a gaming event) to produce haptics for a device.

During operation of the system 200, the DSP 220 can use waveform generation algorithms 224 along with protection algorithms 226, based on the haptic trigger 215 and LRA model parameters 222, to generate short haptic waveforms. The short haptic waveforms can be used to simulate mechanical button clicks to support bezel-less designs (e.g., for mobile phones).

In one or more examples the LRA model parameters 222 can include electrical parameters, derived parameters, and/or mechanical parameters. The electrical parameters can include an electrical coil voice resistance at direct current, a voice coil inductance at first frequencies, a para-inductance at second frequencies lower than the first frequencies, and/or a resistance due to eddy currents. The derived parameters can include an electrical capacitance representing a mechanical mass, an electrical inductance representing a mechanical compliance, a resistance due to mechanical losses, and/or a driver resonance frequency. The mechanical parameters can include a mechanical mass of a proof mass assembly (e.g., one or more LRA magnets, such as the LRA magnets 120 of FIG. 1), a mechanical resistance of total-driver losses, a mechanical stiffness of a driver suspension, a mechanical compliance of the driver suspension, and/or a force factor (e.g., a Bl product).

The digital codec 230 of the DSP 220 can communicate (e.g., transmit) the short haptic waveforms via a voltage command (e.g., over a soundwire protocol) to the PMIC 260. Based on the voltage command, the haptics driver circuitry 240 of the PMIC 260 can generate and send (e.g., apply) a drive voltage to the actuator 250 to drive the actuator 250 to produce an acceleration waveform for generating a haptic effect.

The haptics driver circuitry 240 of the PMIC 260 can monitor (e.g., sense) the actuator 250. The haptics driver circuitry 240 can send the voltage and current sense feedback 242 associated with the actuator 250 to the DSP 220 via the digital codec 230 for actuator resonant frequency f0 and parameter tracking 228.

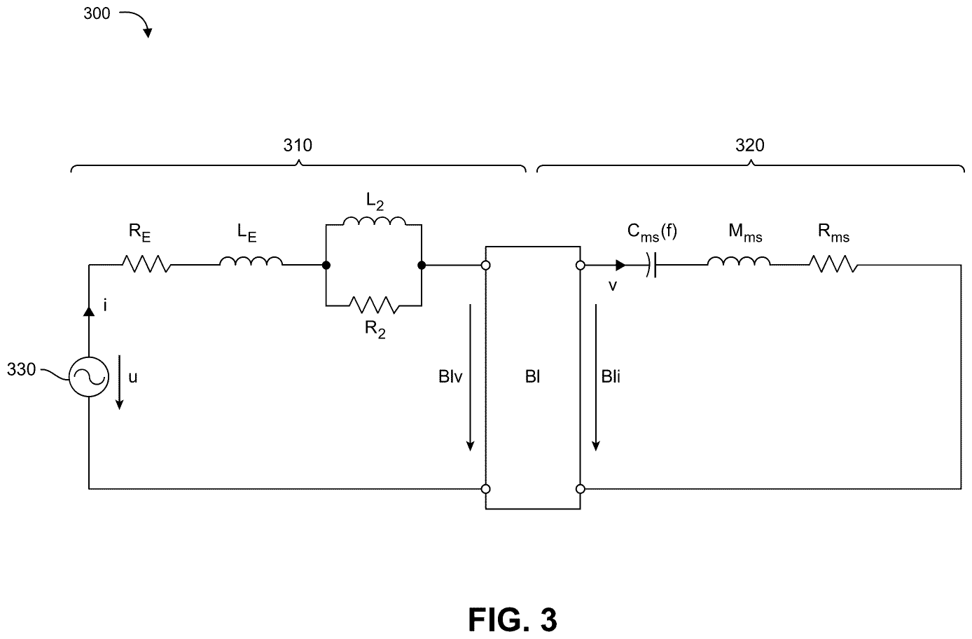

FIG. 3 shows an example linear model for an actuator (e.g., LRA). In particular, FIG. 3 is a diagram illustrating an example of a linear model 300 for modeling an LRA. In FIG. 3, the linear model 300 is shown to include an electrical part 310 (e.g., including resistors R_{E}, R₂, inductors L_{E}, L₂, and a sinusoidal signal generator 330) and a mechanical part 320 (e.g., including a capacitor Cₘₛ (f), an inductor Mₘₛ, and a resistor Rₘₛ) that are coupled together.

As previously mentioned, the key to designing haptic effects is based on knowledge of a resonant frequency of the actuator (e.g., LRA) with a high level of accuracy. Determination of the resonant frequency with accuracy can allow for producing a consistent haptic vibration (e.g., with a maximum possible haptic effect) that does not change with the ageing of the device, the way the device is held (e.g., a tight or loose grip) by a user of the device, and/or the ambient conditions (e.g., humidity and temperature) of the device. Improved systems and techniques for estimating a resonant frequency of an actuator (e.g., LRA) with accuracy, while providing an expected haptic effect to the user during the estimation, can be beneficial.

In one or more aspects, the systems and techniques provide solutions for actuator (e.g., LRA) resonant frequency detection via zero phase tracking. In one or more examples, the systems and techniques can track any change in the resonant frequency during the estimation of the resonant frequency and, thus, are potentially able to estimate a grip (e.g., loose or tight) of the device (e.g., in the form of a smart phone) by a user or estimate tightness of the device (e.g., in the form of a smart watch or head-mounted device) being worn by the user. Existing solutions to estimate the resonant frequency of an actuator (e.g., LRA) assume that the user grip of the device (or tightness of device being worn by the user) does not change during the estimation of the resonant frequency.

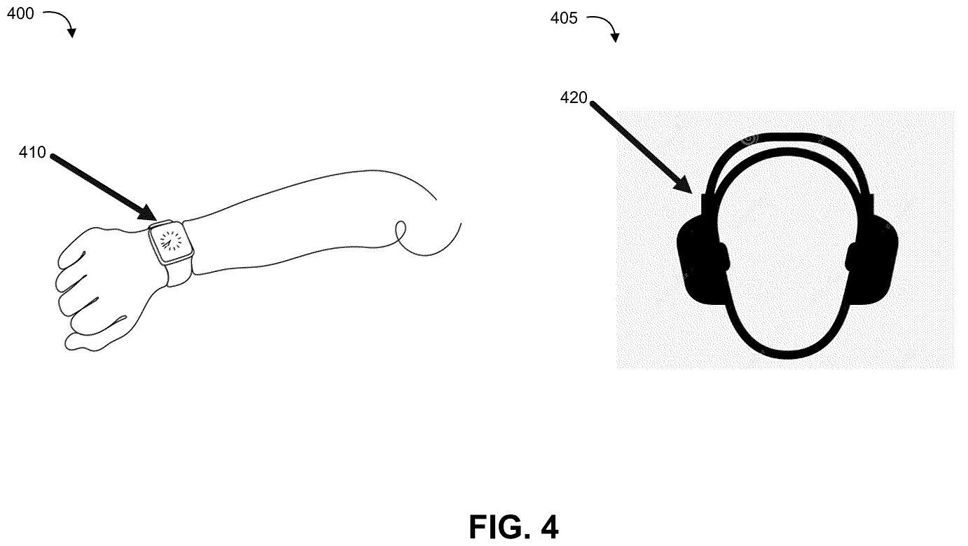

FIG. 4 shows examples of different use cases for the systems and techniques for estimating tightness of a device being worn by a user. In particular, FIG. 4 is a diagram illustrating examples of use cases 400, 405 for actuator (e.g., LRA) resonant frequency detection via zero phase tracking. In FIG. 4, a first use case 400 is shown where a user is wearing a device in the form of a smart watch 410. FIG. 4 also shows a second use case 405 where a user is wearing a device in the form of a head-mounted device (HMD) 420 (e.g., an extended reality device).

For the smart watch 410 of the first use case 400, resonant frequency tracking (e.g., the haptic vibration) could potentially indicate how tightly the smart watch 410 is strapped onto the user's wrist. In addition to indicating the tightness of the strap of the smart watch 410, this information (e.g., the haptic vibration) could be used to increase accuracy of health sensors (e.g., biometric sensors, such as light and imaging sensors for bodily stats) of the smart watch 410, to modulate the strength of the haptic signal itself (e.g., which may be proportional to how tight the smart watch 410 is being worn), and/or to increase the accuracy of fitness sensors (e.g., accelerometer and/or gyroscope sensors) of the smart watch 410 for fitness tracking and identification of exercise and/or motion patterns of the user.

For the HMD 420 of the second use case 405, resonant frequency tracking (e.g., the haptic vibration) could potentially indicate the tightness of fit (e.g., which may indicate sound leakage) of the HMD 420 on the user's head. The tightness of fit can be used for calibration of noise occlusion in active noise control (ANC) systems and/or for calibration of bone conduction microphones.

As previously mentioned, existing approaches to estimate the resonant frequency of an actuator (e.g., LRA) typically employ either a wide spectrum waveform (e.g., a chirp) or a series of short pulses to measure the actuator resonant frequency ringdown. The haptic effects, produced based on these waveforms, are difficult to incorporate into user facing haptic vibrations because these haptic effects are an unexpected vibration pattern for the user. As such, a waveform (e.g., a sinusoid waveform) that is applied to the actuator during the estimation of the resonant frequency of the actuator (e.g., LRA) should be consistent such that the actuator produces a haptic effect that is an expected vibration pattern for the user. In addition, the waveform that is applied to the actuator during the estimation of the resonant frequency of the actuator (e.g., LRA) should be as short as possible, because longer waveforms are usually only used for ringtone waveforms with a lower frequency, which can lower the probability of estimating the resonant frequency frequently.

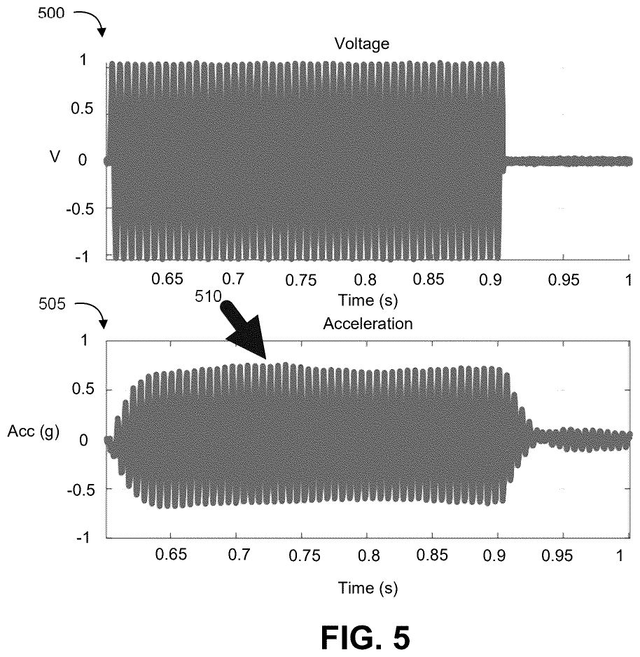

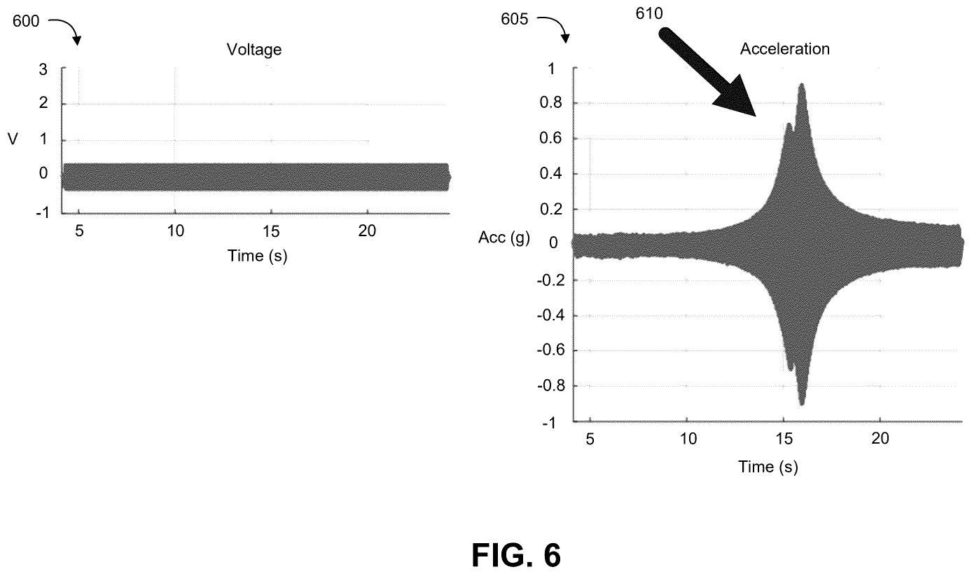

FIGS. 5 and 6 show examples of different acceleration profiles of an actuator (e.g., LRA) that produce different haptic effects. In particular, FIG. 5 is a diagram illustrating an example of an acceleration profile of an actuator that produces a familiar haptic experience to a user. In FIG. 5, a graph 500 and a graph 505 are shown. For the graph 500, the x-axis denotes time in seconds(s), and the y-axis denotes voltage in volts (V). For the graph 505, the x-axis denotes time in seconds, and the y-axis denotes acceleration in g-force (g).

The graph 505 of FIG. 5 shows a uniform acceleration profile 510, which is produced by an actuator when a short sinusoidal waveform is applied to the actuator to estimate the resonant frequency of an actuator. This uniform acceleration profile 510 creates a user experience that is a familiar haptic experience for the user. The graph 500 of FIG. 6 shows a sensed voltage of the actuator that corresponds to the acceleration profile of the graph 505.

FIG. 6 is a diagram illustrating an example of an acceleration profile of an actuator that produces a haptic experience that is unusual to a user. In FIG. 6, a graph 600 and a graph 605 are shown. For the graph 600, the x-axis denotes time in seconds, and the y-axis denotes voltage in volts. For the graph 605, the x-axis denotes time in seconds, and the y-axis denotes acceleration in g-force.

The graph 605 of FIG. 6 shows an acceleration profile including a peak 610, which is produced by an actuator when a wide spectrum waveform (e.g., a chirp) is applied to the actuator to estimate the resonant frequency of an actuator. This acceleration profile creates a haptic experience that is an unusual experience for the user. The haptic effect, as shown in the acceleration profile of graph 605, gets stronger and softer within the chirp. The graph 600 of FIG. 6 shows a sensed voltage of the actuator that corresponds to the acceleration profile of the graph 605.

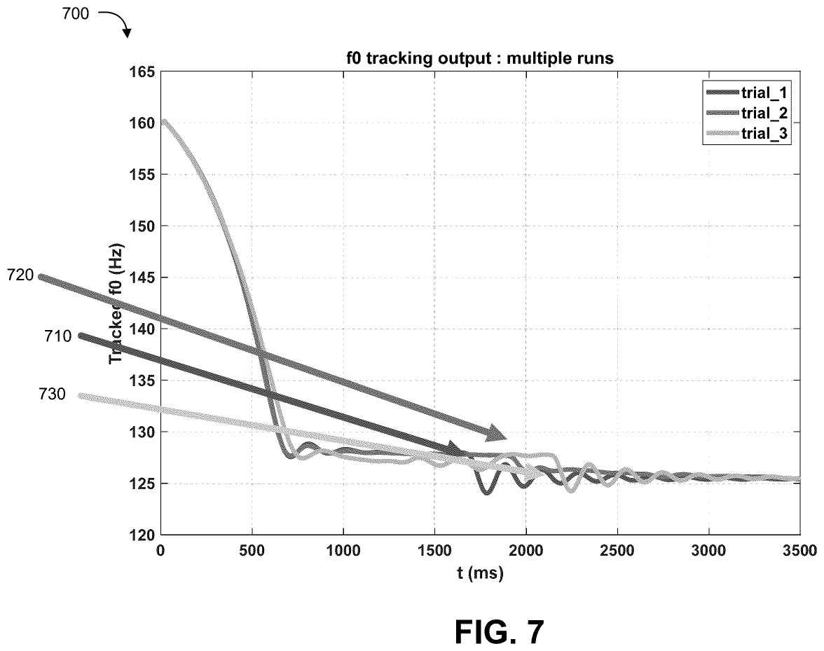

As previously mentioned, the resonance frequency can change based on the grip of a device (e.g., a mobile phone) by a user or based on the tightness of the device being worn (e.g., a smart watch or an HMD) by a user. FIG. 7 shows examples of changes in the resonant frequency of a device (e.g., a mobile device), including an actuator (e.g., LRA), based on different grips (e.g., tight or loose) on the device by the user. In particular, FIG. 7 is a graph 700 illustrating examples of resonant frequencies of an actuator (e.g., LRA) based on different grips of a device by a user. For the graph 700 of FIG. 7, the x-axis denotes time in milliseconds (ms), and the y-axis denotes the tracked resonant frequency (f0) in Hertz (Hz). The graph 700 shows the detected resonant frequency (f0) over time for different grip conditions (e.g., a loose grip 720, a medium grip 710, and a tight grip 730) of the device by the user. The graph 700 shows that the resonant frequency (f0) changes as the grip condition (e.g., grip force) changes on the device.

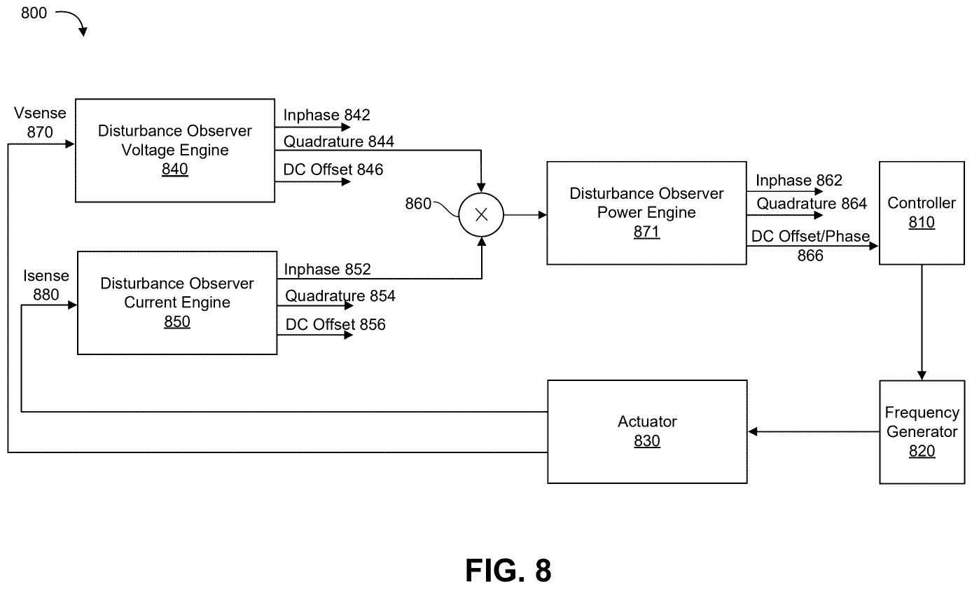

FIG. 8 shows an example system for resonant frequency detection via zero phase tracking. In particular, FIG. 8 is diagram illustrating an example of a system 800 for actuator (e.g., LRA) resonant frequency detection via zero phase tracking. In FIG. 8, the system 800 is shown to include an actuator 830 (e.g., an LRA), a controller 810 (e.g., a proportional integral (PI) controller), a frequency generator 820, a disturbance observer voltage engine 840, a disturbance observer current engine 850, a disturbance observer power engine 871, and a multiplier 860. In one or more examples, the system 800 may be associated with (e.g., housed within or connected to) a device, which may be associated with a user. In some examples, the device may be a mobile device. In one or more examples, the mobile device may be a mobile phone, a smart watch, or an HMD.

In one or more examples, during operation of the system 800 of FIG. 8 for producing one or more haptics effects at the device, the controller 810 can command the frequency generator 820 to generate a signal with a frequency that may be updated (or swept) over time. For example, the controller 810 can command the frequency generator 820 to generate a signal with frequency that is updated or swept (e.g., gradually adjusted) from 170 Hz to 180 Hz over a specified period of time (e.g., until the measure of the phase difference is equal to zero (0) and/or until a resonant frequency is determined). In one or more examples, the signal may be a sinusoidal signal. In one or more examples, the frequency of the signal can be continuously updated/swept over the time during operation of the device by the user. In some examples, the frequency of the signal can be updated/swept based on a previously known resonant frequency of the actuator 830 or based on manufacturer tolerances of a specified resonant frequency (e.g., within a specification) of the actuator 830.

The frequency generator 820, based on receiving the command from the controller 810, can apply, to the actuator 830, the signal with the frequency updated/swept over time. The actuator 830 can generate, based on the signal, a voltage 870 (e.g., a sensed voltage, which may be referred to as Vsense) and a current 880 (e.g., a sensed current, which may be referred to as Isense). In one or more examples, the voltage 870 may be expressed as V=Vₘ sin ωt, and the current 880 may be expressed as I=Iₘ sin(ωt+φ).

The disturbance observer voltage engine 840 (e.g., which may include or be run by one or more processors), based on the voltage 870, can determine an in-phase component of the voltage 842, a quadrature component of the voltage 844, and an offset (e.g., direct current (DC) offset) of the voltage 846. In one or more examples, the quadrature component of the voltage 844 may be expressed as Vₘ cos(ωt).

The disturbance observer current engine 850 (e.g., which may include or be run by one or more processors), based on the current 880, can determine an in-phase component of the current 852, a quadrature component of the current 854, and an offset (e.g., DC offset) of the current 856. In one or more examples, the in-phase component of the current 852 may be expressed as Iₘ sin (ωt+φ).

The multiplier 860 can multiply the quadrature component of the voltage 844 and the in-phase component of the current 852 to generate a power. The multiplication of the quadrature component of the voltage 844 and the in-phase component of the current 852 to generate the power can be expressed as P=Iₘ sin(ωt+φ)Vₘ cos(ωt), which is equivalent to

$$P = \frac{{V}_{m}^{2}}{2} \vert \frac{t ( s )}{V ( s )} \vert ( sin ( 2 ω t + φ ) + sin ( φ ) ) .$$

The disturbance observer power engine 871 (e.g., which may include or be run by one or more processors), based on the power, can determine an in-phase component of the power 862, a quadrature component of the power 864, and an offset (e.g., DC offset) phase of the power 866. In one or more examples, an offset phase (e.g., DC offset phase) of the power 866 may be expressed as

$${P}_{de} = \frac{{V}_{m}^{2}}{2} \vert \frac{t ( s )}{V ( s )} \vert sin ( φ ) .$$

The offset phase (e.g., the DC offset phase) provides a measure of the phase difference between the current and the voltage.

One or more processors can monitor (e.g., as the frequency of the signal is updated or swept over time) the measure of the phase difference between the current and the voltage (which is based on the offset phase of the power 866, as noted above). The one or more processors can determine, based on determining the measure of the phase difference (which is based on the offset phase of the power 866) is equal to zero (0), that the frequency is the resonant frequency (f0) of the actuator 830. The actuator 830 can produce, based on operating at the resonant frequency, the one or more haptic effects at the device. In one or more examples, the resonant frequency of the actuator 830 can be dependent upon a grip of the device by the user, tightness of wear of the device by the user, aging of the device, ambient conditions of the device, a temperature of the device, and/or a humidity of the device.

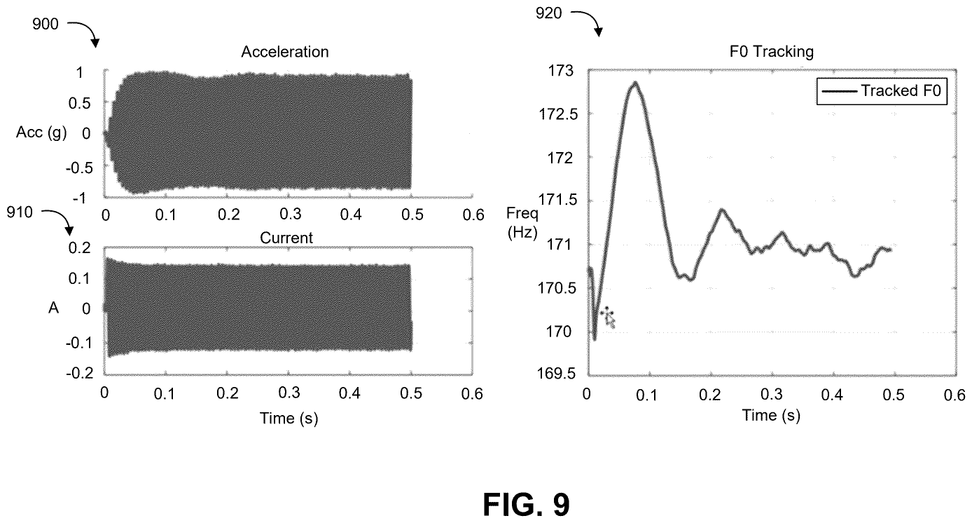

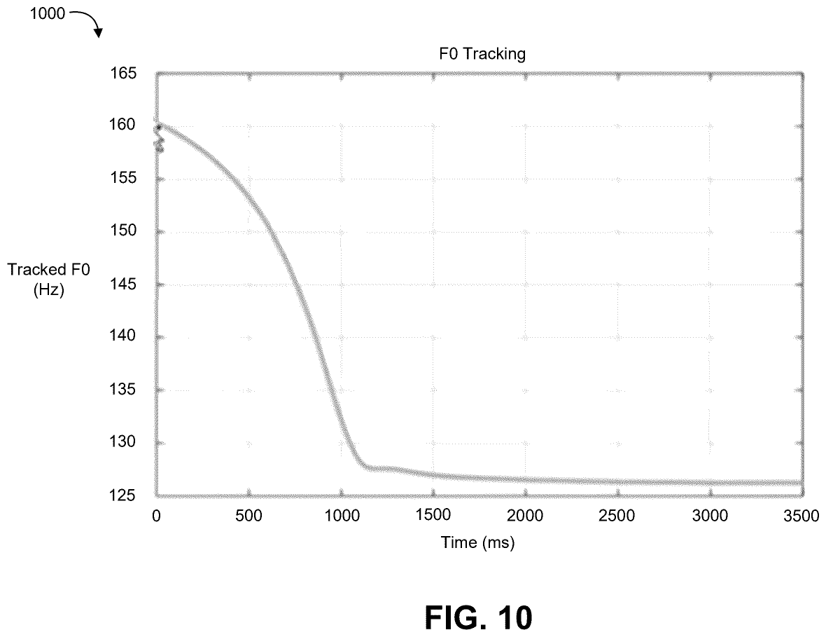

In one or more examples, an amount of time required to detect the resonant frequency of an actuator (e.g., actuator 830) can depend upon the span of frequencies of the signal that are updated/swept over time. FIGS. 9 and 10 show different examples of tracking a resonant frequency of an actuator over time. In particular, FIG. 9 is a diagram illustrating an example of tracking a resonant frequency of an actuator (e.g., LRA) when updating (or sweeping) a frequency applied to actuator over time. In FIG. 9, a graph 900, a graph 910, and a graph 920 are shown. For the graph 900, the x-axis denotes time in seconds, and the y-axis denotes g-force. For the graph 910, the x-axis denotes time in seconds, and the y-axis denotes amperes (A). For the graph 920, the x-axis denotes time in seconds, and the y-axis denotes the tracked frequency (f0) in Hertz (Hz).

The graph 920 of FIG. 9 shows the tracking of the resonant frequency (f0) of an actuator over time. As shown in the graph 920, the tracking begins with the frequency updated/swept from a starting point of 170 Hz. The graph 920 shows that the resonant frequency of 171 Hz is detected after approximately 0.2 seconds or 200 milliseconds.

The graph 900 of FIG. 9 shows a sensed voltage of the actuator that corresponds to the graph 920 tracking the resonant frequency of the actuator. The graph 910 of FIG. 9 shows a sensed current of the actuator that corresponds to the graph 920 tracking the resonant frequency of the actuator.

FIG. 10 is a diagram illustrating another example of tracking a resonant frequency of an actuator (e.g., LRA) when updating (or sweeping) a frequency applied to actuator over time. In FIG. 9, a graph 1000 is shown. For the graph 1000, the x-axis denotes time in seconds, and the y-axis denotes the tracked frequency (f0) in Hertz (Hz).

The graph 1000 of FIG. 10 shows the tracking of the resonant frequency (f0) of an actuator over time. As shown in the graph 1000, the tracking begins with the frequency updated/swept from a starting point of 160 Hz. The graph 1000 shows that the resonant frequency of 127 Hz is detected after approximately 1500 milliseconds or 1.5 seconds.

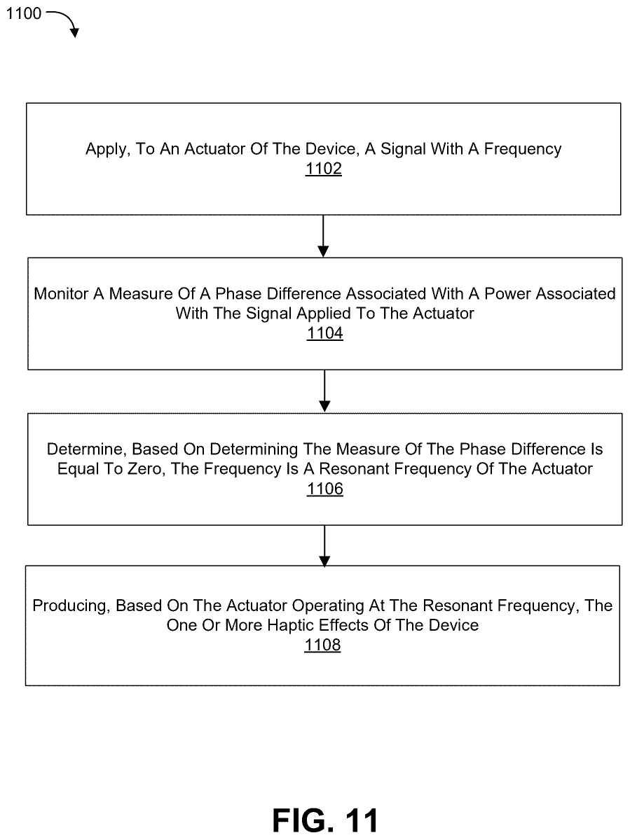

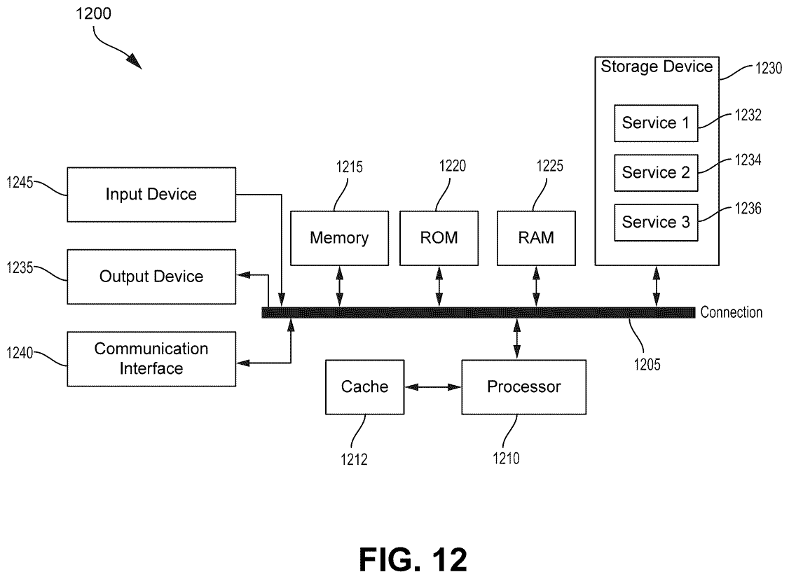

FIG. 11 is a flow chart illustrating an example of a process 1100 for actuator (e.g., LRA) resonant frequency detection via zero phase tracking. The process 1100 can be performed by a computing device (e.g., a computing device or computing system 1200 of FIG. 12) or by a component or system (e.g., a chipset, one or more processors such as one or more central processing units (CPUs), digital signal processors (DSPs), graphics processing units (GPUs), the controller 810 of FIG. 8, the frequency generator 820 of FIG. 8, the actuator 830 of FIG. 8, the disturbance observer voltage engine 840 of FIG. 8, the disturbance observer current engine 850 of FIG. 8, the disturbance observer power engine 871, any combination thereof, and/or other type of processor(s), or other component or system) of the computing device. In some cases, the computing device is a mobile device, a wearable device (e.g., smartwatch, smart-glasses, wearable ring, etc.), an extended reality (XR) device (e.g., a virtual reality (VR) headset, an augmented reality (AR) headset or glasses, or a mixed reality (MR) headset), a vehicle (e.g., automobile, motorcycle, bicycle, etc.), an Internet of Things (IoT) device, or other type of device. The operations of the process 1100 may be implemented as software components that are executed and run on one or more processors (e.g., processor 1210 of FIG. 12, or other processor(s)). Further, the transmission and reception of signals by the computing device in the process 1100 may be enabled, for example, by one or more antennas and/or one or more transceivers (e.g., wireless transceiver(s)).

At block 1102, the computing device (or component thereof) can apply, to an actuator (e.g., the actuator 830 of FIG. 8) of the device, a signal with a frequency (e.g., a sinusoidal signal or other type of signal). In some cases, the actuator is a linear resonant actuator (LRA) or other type of actuator. In some aspects, a frequency generator (e.g., the frequency generator 820 of FIG. 8) can generate the signal with the frequency. In some cases, a component of the computing device (e.g., the controller 810 of FIG. 8) can cause the signal to be applied to the actuator. In one illustrative example, as described herein, the controller 810 of FIG. 8 can command the frequency generator 820 to generate the signal with the frequency. In such an example, based on receiving the command from the controller 810, the frequency generator 820 can apply the signal to the actuator 830.

In some aspects, the frequency of the signal is updated over time. For instance, the frequency of the signal can be updated (or swept) over time until the measure of the phase difference is equal to zero (e.g., until a resonant frequency is determined). In some cases, the frequency of the signal is updated based on a previously known resonant frequency of the actuator or manufacturer tolerances of a specified resonant frequency of the actuator. In some cases, the resonant frequency is dependent upon a grip of the computing device by a user, tightness of wear of the computing device by the user, aging of the computing device, ambient conditions of the computing device, a temperature of the computing device, a humidity of the computing device, any combination thereof, and/or based on other factors.

At block 1104, the computing device (or component thereof) can monitor a measure of a phase difference associated with a power associated with the signal applied to the actuator. In some aspects, the measure of the phase difference is based on an offset phase of the power. In some cases, the offset phase of the power is a direct current (DC) offset phase. In some aspects, the computing device (or component thereof) can generate, by the actuator based on the signal, a voltage and a current. In such aspects, the measure of the phase difference is between the current and the voltage. For instance, as described above with respect to FIG. 8, the actuator 830 can generate, based on the signal, a voltage 870 (e.g., a sensed voltage, which may be referred to as Vsense) and a current 880 (e.g., a sensed current, which may be referred to as Isense).

In some aspects, the computing device (or component thereof) can multiply a quadrature component of the voltage and an in-phase component of the current to generate the power. For instance, as described with respect to FIG. 8 the disturbance observer voltage engine 840 of FIG. 8 can determine, based on the voltage 870, an in-phase component of the voltage 842 and a quadrature component of the voltage 844. The disturbance observer voltage engine 840 can determine an offset (e.g., direct current (DC) offset) of the voltage 846. The disturbance observer current engine 850 of FIG. 8 can determine, based on the current 880, an in-phase component of the current 852 and a quadrature component of the current 854. The disturbance observer current engine 850 can determine an offset (e.g., DC offset) of the current 856. The multiplier 860 of FIG. 8 can then multiply the quadrature component of the voltage 844 and the in-phase component of the current 852 to generate the power. Based on the power, the disturbance observer power engine 871 can determine an in-phase component of the power 862, a quadrature component of the power 864, and an offset phase (e.g., a DC offset phase) of the power 866. The offset phase (e.g., the DC offset phase) provides the measure of the phase difference between the current and the voltage that is monitored by the computing device (or component thereof).

At block 1106, the computing device (or component thereof) can determine, based on determining the measure of the phase difference is equal to zero, the frequency is a resonant frequency (e.g., resonant frequency f0) of the actuator.

At block 1108, the computing device (or component thereof) can produce, based on the actuator operating at the resonant frequency, the one or more haptic effects at the device.

As noted previously, the computing device configured to perform the process 1100 may include various components. The one or more components can include one or more input devices, one or more output devices, one or more processors, one or more microprocessors, one or more microcomputers, one or more cameras, one or more sensors, the frequency generator 820 of FIG. 8, the actuator 830 of FIG. 8, the disturbance observer voltage engine 840 of FIG. 8, the disturbance observer current engine 850 of FIG. 8, the disturbance observer power engine 871, any combination thereof, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1100 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1100 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a block diagram illustrating an example of a computing system 1200, which may be employed for actuator (e.g., LRA) resonant frequency detection via zero phase tracking. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LiDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A method for producing one or more haptic effects at a device, the method comprising: applying, to an actuator of the device, a signal with a frequency; monitoring a measure of a phase difference associated with a power associated with the signal applied to the actuator; determining, based on determining the measure of the phase difference is equal to zero, the frequency is a resonant frequency of the actuator; and producing, based on the actuator operating at the resonant frequency, the one or more haptic effects at the device.
Aspect 2. The method of Aspect 1, wherein the frequency of the signal is updated over time until the measure of the phase difference is equal to zero.
Aspect 3. The method of Aspect 2, wherein the frequency of the signal is updated based on a previously known resonant frequency of the actuator or manufacturer tolerances of a specified resonant frequency of the actuator.
Aspect 4. The method of any of Aspects 1 to 3, wherein the resonant frequency is dependent upon at least one of a grip of the device by a user, tightness of wear of the device by the user, aging of the device, ambient conditions of the device, a temperature of the device, or a humidity of the device.
Aspect 5. The method of any of Aspects 1 to 4, further comprising generating, by the actuator based on the signal, a voltage and a current, wherein the measure of the phase difference is between the current and the voltage.
Aspect 6. The method of Aspect 5, further comprising multiplying a quadrature component of the voltage and an in-phase component of the current to generate the power.
Aspect 7. The method of any of Aspects 1 to 6, wherein the measure of the phase difference is based on an offset phase of the power.
Aspect 8. The method of Aspect 7, wherein the offset phase of the power is a direct current (DC) offset phase.
Aspect 9. The method of any of Aspects 1 to 8, wherein the actuator is a linear resonant actuator (LRA).
Aspect 10. The method of any of Aspects 1 to 9, wherein the signal is sinusoidal.
Aspect 11. The method of any of Aspects 1 to 10, wherein the device is a mobile device, a wearable device, or an extended reality (XR) device.
Aspect 12. An apparatus for producing one or more haptic effects, the apparatus comprising: at least one memory; and at least one processor coupled to the at least one memory and configured to: cause a signal with a frequency to be applied to an actuator; monitor a measure of a phase difference associated with a power associated with the signal applied to the actuator; determine, based on a determination that the measure of the phase difference is equal to zero, the frequency is a resonant frequency of the actuator; and based on the actuator operating at the resonant frequency, cause the one or more haptic effects to be output at the apparatus.
Aspect 13. The apparatus of Aspect 12, wherein the frequency of the signal is continuously updated over time until the measure of the phase difference is equal to zero.
Aspect 14. The apparatus of Aspect 13, wherein the frequency of the signal is updated based on a previously known resonant frequency of the actuator or manufacturer tolerances of a specified resonant frequency of the actuator.
Aspect 15. The apparatus of any of Aspects 12 to 14, wherein the resonant frequency is dependent upon at least one of a grip of the apparatus by a user, tightness of wear of the apparatus by the user, aging of the apparatus, ambient conditions of the apparatus, a temperature of the apparatus, or a humidity of the apparatus.
Aspect 16. The apparatus of any of Aspects 13 to 16, further comprising the actuator.
Aspect 17. The apparatus of Aspect 16, wherein the actuator is configured to generate, based on the signal, a voltage and a current, wherein the measure of the phase difference is between the current and the voltage.
Aspect 18. The apparatus of Aspect 17, wherein the at least one processor is configured to multiply a quadrature component of the voltage and an in-phase component of the current to generate the power.
Aspect 19. The apparatus of any of Aspects 12 to 18, wherein the actuator is a linear resonant actuator (LRA).
Aspect 20. The apparatus of any of Aspects 12 to 19, wherein the measure of the phase difference is based on an offset phase of the power.
Aspect 21. The apparatus of Aspect 20, wherein the offset phase of the power is a direct current (DC) offset phase.
Aspect 22. The apparatus of any of Aspects 12 to 21, wherein the signal is sinusoidal.
Aspect 23. The apparatus of any of Aspects 12 to 22, wherein the apparatus is a device or a part of the device.
Aspect 24. The apparatus of Aspect 23, wherein the device is a mobile device, a wearable device, or an extended reality (XR) device.
Aspect 25. The apparatus of any of Aspects 12 to 24, further comprising a frequency generator configured to: generate the signal with the frequency; and apply the frequency to the actuator.
Aspect 26. A non-transitory computer-readable medium having stored thereon instructions that, when executed by at least one processor, cause the at least one processor to perform operations according to any of Aspects 12 to 25.
Aspect 28. An apparatus for generating virtual content in a distributed system, the apparatus including one or more means for performing operations according to any of Aspects 12 to 25.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for producing one or more haptic effects, the apparatus comprising:
at least one memory; and
at least one processor coupled to the at least one memory and configured to:
cause a signal with a frequency to be applied to an actuator;
monitor a measure of a phase difference associated with a power associated with the signal applied to the actuator;
determine, based on a determination that the measure of the phase difference is equal to zero, the frequency is a resonant frequency of the actuator; and
based on the actuator operating at the resonant frequency, cause the one or more haptic effects to be output at the apparatus.

2. The apparatus of claim 1, wherein the frequency of the signal is continuously updated over time until the measure of the phase difference is equal to zero.

3. The apparatus of claim 2, wherein the frequency of the signal is updated based on a previously known resonant frequency of the actuator or manufacturer tolerances of a specified resonant frequency of the actuator.

4. The apparatus of claim 1, wherein the resonant frequency is dependent upon at least one of a grip of the apparatus by a user, tightness of wear of the apparatus by the user, aging of the apparatus, ambient conditions of the apparatus, a temperature of the apparatus, or a humidity of the apparatus.

5. The apparatus of claim 1, further comprising the actuator.

6. The apparatus of claim 5, wherein the actuator is configured to generate, based on the signal, a voltage and a current, wherein the measure of the phase difference is between the current and the voltage.

7. The apparatus of claim 6, wherein the at least one processor is configured to multiply a quadrature component of the voltage and an in-phase component of the current to generate the power.

8. The apparatus of claim 1, wherein the actuator is a linear resonant actuator (LRA).

9. The apparatus of claim 1, wherein the measure of the phase difference is based on an offset phase of the power.

10. The apparatus of claim 9, wherein the offset phase of the power is a direct current (DC) offset phase.

11. The apparatus of claim 1, wherein the signal is sinusoidal.

12. The apparatus of claim 1, wherein the apparatus is a device or a part of the device.

13. The apparatus of claim 12, wherein the device is a mobile device, a wearable device, or an extended reality (XR) device.

14. The apparatus of claim 1, further comprising a frequency generator configured to:
generate the signal with the frequency; and
apply the frequency to the actuator.

15. A method for producing one or more haptic effects at a device, the method comprising:
applying, to an actuator of the device, a signal with a frequency;
monitoring a measure of a phase difference associated with a power associated with the signal applied to the actuator;
determining, based on determining the measure of the phase difference is equal to zero, the frequency is a resonant frequency of the actuator; and
producing, based on the actuator operating at the resonant frequency, the one or more haptic effects at the device.

16. The method of claim 15, wherein the frequency of the signal is updated over time until the measure of the phase difference is equal to zero.

17. The method of claim 15, wherein the resonant frequency is dependent upon at least one of a grip of the device by a user, tightness of wear of the device by the user, aging of the device, ambient conditions of the device, a temperature of the device, or a humidity of the device.

18. The method of claim 15, further comprising generating, by the actuator based on the signal, a voltage and a current, wherein the measure of the phase difference is between the current and the voltage.

19. The method of claim 15, wherein the measure of the phase difference is based on an offset phase of the power.

20. The method of claim 15, wherein the actuator is a linear resonant actuator (LRA).
